(19) United States
(12) Patent Application Publication
(10) Pub. No.: US 2023/0123671 A1
(43) Pub. Date: Apr. 20, 2023

(54) LOCALIZATION AND MAPPING

(71) Applicant: BEIJING BAIDU NETCOM SCIENCE TECHNOLOGY CO., LTD., BEIJING (CN)

(72) Inventors: Xiaobo WAN, Beijing (CN); Yueqiang DONG, Beijing (CN); Kang WANG, Beijing (CN); Xianpeng MENG, Beijing (CN)

(21) Appl. No.: 18/069,856

(22) Filed: Dec. 21, 2022

(30) Foreign Application Priority Data
Dec. 23, 2021 (CN) 202111591990.7

(51) Int. Cl. G06T 7/73

(52) U.S. Cl. CPC G06T 7/74; G06T 2207/10028

(57) ABSTRACT

A method for localization and mapping is provided. The method includes: determining a first estimated pose of a current frame based on a matching result of scan data of the current frame and a first submap and a pose of the first submap, where the first submap includes scan data of a common-viewing-angle frame; adding the scan data of the current frame into the first submap; determining a plurality of candidate poses around the first estimated pose; matching the scan data of the current frame with the second submap based on each candidate pose and a pose of each second submap to determine a score of each candidate pose, and determining a second estimated pose of the current frame corresponding to the second submap; determining a third estimated pose from the at least one second estimated pose; updating the scan data based on the third estimated pose.

### CROSS-REFERENCE TO RELATED APPLICATION

This application claims priority to Chinese Patent Application No. 202111591990.7, filed on Dec. 23, 2021, the contents of which are hereby incorporated by reference in their entirety for all purposes.

### TECHNICAL FIELD

The present disclosure relates to the technical field of computers and the field of robots, specifically relates to a localization and mapping technology, in particular to a method for localization and mapping, an apparatus for localization and mapping, an electronic device, a computer-readable storage medium and a computer program product.

### BACKGROUND

In a laser simultaneous localization and mapping (SLAM) system, pose estimation of a current frame depends on a matching result of the current frame and a current submap or pose estimation of a preceding frame. Such estimation mode will cause an error, so further pose accuracy detection and error correction need to be performed.

A technique described in this part is not necessarily a technique envisaged or adopted before. Unless otherwise indicated, it should not be presumed that any of techniques described in this part is regarded as the prior art only based on it being included in this part. Likewise, unless otherwise indicated, the problem mentioned in this part should not be construed as being recognized in any prior art.

### SUMMARY

The present disclosure provides a method for localization and mapping, an apparatus for localization and mapping, an electronic device, a computer-readable storage medium and a computer program product.

According to an aspect of the present disclosure, a method for localization and mapping is provided and includes: determining a first estimated pose of a current frame at least based on a pose of the first submap and a matching result of scan data of the current frame and a first submap, where the first submap includes scan data of at least one preceding frame with the same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame; adding the scan data of the current frame into the first submap based on the first estimated pose and the pose of the first submap; determining a plurality of candidate poses within a range around the first estimated pose; for each second submap of at least one second submap: matching the scan data of the current frame with the second submap based on each candidate pose of the plurality of candidate poses and a pose of the second submap to determine a score of the plurality of candidate poses in the second submap; and determining a second estimated pose of the current frame corresponding to the second submap from the plurality of candidate poses based on the score of the plurality of candidate poses in the second submap; in response to determining that a score of each second estimated pose of the at least one second estimated pose of the current frame corresponding to the at least one second submap in the corresponding second submap meets a predetermined condition, determining a third estimated pose of the current frame from the at least one second estimated pose of the current frame; and updating the scan data of the current frame in the first submap based on the third estimated pose of the current frame.

According to an aspect of the present disclosure, an electronic device is provided and includes: one or more processors; a memory storing one or more programs configured to be executed by the one or more processors, the one or more programs including instructions for: determining a first estimated pose of a current frame at least based on a pose of the first submap a matching result of scan data of the current frame and a first submap, where the first submap includes scan data of at least one preceding frame with the same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame; adding the scan data of the current frame into the first submap based on the first estimated pose and the pose of the first submap; determining a plurality of candidate poses within a range around the first estimated pose; for each second submap of at least one second submap: matching the scan data of the current frame with the second submap based on each candidate pose of the plurality of candidate poses and a pose of the second submap to determine a score of the plurality of candidate poses in the second submap; and determining a second estimated pose of current frame corresponding to the second submap from the plurality of candidate poses based on the score of the plurality of candidate poses in the second submap; in response to determining that a score of each second estimated pose of at least one second estimated pose of the current frame corresponding to the at least one second submap in the corresponding second submap meets a predetermined condition, determining a third estimated pose of the current frame from the at least one second estimated pose of the current frame; and updating the scan data of the current frame in the first submap based on the third estimated pose.

According to an aspect of the present disclosure, a non-transient computer-readable storage medium storing one or more programs is provided. The one or more programs including instructions, which when executed by one or more processors of an electronic device, cause the electronic device to: determine a first estimated pose of a current frame at least based on a pose of the first submap and a matching result of scan data of the current frame and a first submap, where the first submap includes scan data of at least one preceding frame with the same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame; add the scan data of the current frame into the first submap based on the first estimated pose and the pose of the first submap; determine a plurality of candidate poses within a range around the first estimated pose; for each second submap of at least one second submap: match the scan data of the current frame with the second submap based on each candidate pose of the plurality of candidate poses and a pose of the second submap to determine a score of the plurality of candidate poses in the second submap; and determine a second estimated pose of the current frame corresponding to the second submap from the plurality of candidate poses based on the score of the plurality of candidate poses in the second submap; in response to determining that a score of each second estimated pose of at least one second estimated pose of the current frame corresponding to the at least one second submap in the corresponding second submap meets a predetermined condition, determine a third estimated pose of the current frame from the at least one second estimated pose of the current frame; and update the scan data of the current frame in the first submap based on the third estimated pose of the current frame.

According to one or more embodiments of the present disclosure, by matching the scan data of the current frame with the first submap composed of the scan data of the preceding frame with the same viewing angle as the current frame, a rough pose estimation result of the current frame is obtained based on the pose of the first submap; then the scan data are further matched with the at least one second submap based on the result so as to obtain an accurate pose estimation result; and the scan data are fused into the first submap based on the result, and fast localization and mapping are realized. The method can be applied to a small platform with relatively weak hashrate and can meet an output demand.

It should be understood that the described contents in this part are neither intended to identify key or important features of the embodiments of the present disclosure, nor used to limit the scope of the present disclosure. Other features of the present disclosure will become easier to understand through the following specification.

### BRIEF DESCRIPTION OF THE DRAWINGS

Accompanying drawings, constituting a part of the specification, illustrate embodiments and, together with text description of the specification, serve to explain example implementations of the embodiments. The illustrated embodiments only aim to serve as examples rather than limit the scope of the claims. In all the accompanying drawings, same reference numbers represent similar but not necessarily the same elements.

FIG. 1 shows a flowchart of a method for localization and mapping according to an example embodiment of the present disclosure.

FIG. 2 shows a flowchart of a method for localization and mapping according to an example embodiment of the present disclosure.

FIG. 3 shows a structural block diagram of an apparatus for localization and mapping according to an example embodiment of the present disclosure.

FIG. 4 shows a structural block diagram of an example electronic device capable of being used for implementing embodiments of the present disclosure.

### DETAILED DESCRIPTION

The example embodiments of the present disclosure are described below with reference to the accompanying drawings, which include various details of the embodiments of the present disclosure for the sake of better understanding and should be constructed as being only examples. Therefore, those ordinarily skilled in the art should realize that various changes and modifications can be made for the embodiments described herein without departing from the scope of the present disclosure. Similarly, for the sake of being clear and concise, description for known functions and structures is omitted in the following description.

In the present disclosure, unless otherwise stated, terms such as “first” and “second” used for describing various elements are not intended to limit a position relation, a sequence relation or a significance relation of these elements and are only used for distinguishing one component from another component. In some examples, a first element and a second element may refer to the same instance of the elements, which, under certain circumstances, may also refer to different instances on the basis of the context.

Terms used in the description of the various examples in the present disclosure only aim to describe specific examples rather than intend to make a limitation. Unless otherwise indicated clearly in the context, the quantity of the elements may be one or more without particularly limiting the quantity of the elements. Besides, a term “and/or” used in the present disclosure covers any one or all possible combinations of all listed items.

Inventors recognized that, in a loopback detection link, pose constraint solving needs to be performed between scan data of a current frame and all submaps, furthermore, pose constraint calculation needs to be performed between a current submap and all the submaps, and consumption of a hashrate is large.

In an example, under a hashrate platform with a smaller size and a weaker hashrate, for example, an industrial personal computer with a CPU being intel i5@1.7 GHz, its SLAM mapping and localization effects have apparent delay and stacking of to-be-processed tasks, a mapping and localization result has a deformation in whole and an error of a mapping scale due to not timely processing of a data stream, and even a local mapping effect has serious ghosting. Under a hashrate platform in this level, the mapping and localization accuracy and real-time property cannot meet a localization navigation requirement of a robot, that is, cannot be used as apriori map localization information and a judgement basis of autonomous motion of the robot, and an algorithm is expected to run under a platform with a smaller size and a lower cost in spite of a perspective of cost or complete machine assembly of the robot, and an output demand of the algorithm is met.

The present disclosure solves, among others, the above technical problem by matching scan data of a current frame with a first submap composed of scan data of a preceding frame with the same viewing angle as the current frame, a rough pose estimation result of the current frame is obtained based on the pose of the first submap; then the scan data are further matched with the at least one second submap based on the result so as to obtain an accurate pose estimation result; and the scan data are fused into the first submap based on the result, and fast localization and mapping are realized. The method can be applied to a small platform with the relatively weak hashrate and can meet an output demand.

The embodiments of the present disclosure will be described in detail below with reference to the accompanying drawings.

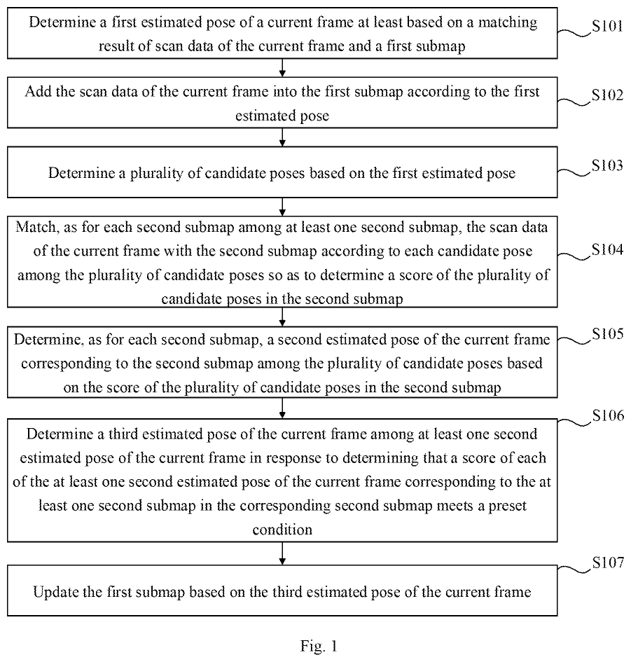

According to an aspect of the present disclosure, a method for localization and mapping is provided. As shown in FIG. 1, the method includes: step S101, a first estimated pose of a current frame is determined at least based on a matching result of scan data of the current frame and a first submap, wherein the first submap includes scan data of at least one preceding frame with the same viewing angle as the current frame; step S102, the scan data of the current frame are added into the first submap according to the first estimated pose; step S103, a plurality of candidate poses are determined based on the first estimated pose; step S104, as for each second submap among at least one second submap: the scan data of the current frame are matched with the second submap according to each candidate pose among the plurality of candidate poses so as to determine a score of the plurality of candidate poses in the second submap; step S105, as for each second submap, based on the score of the plurality of candidate poses in the second submap, a second estimated pose of the current frame corresponding to the second submap is determined among the plurality of candidate poses; step S106, a third estimated pose of the current frame is determined among at least one second estimated pose of the current frame in response to determining that a score of each of the at least one second estimated pose of the current frame corresponding to the at least one second submap in the corresponding second submap meets a preset condition; and step S107, the first submap is updated based on the third estimated pose of the current frame.

Accordingly, by matching the scan data of the current frame with the first submap composed of scan data of the preceding frame with the same viewing angle as the current frame, a rough pose estimation result of the current frame is obtained based on a pose of the first submap; then the scan data are further matched with the at least one second submap based on the result so as to obtain an accurate pose estimation result; and the scan data are fused into the first submap based on the result, and fast localization and mapping are realized. The method can be applied to a small platform with relatively weak hashrate and can meet an output demand.

A platform which runs the above method for localization and mapping may be, for example, a platform built in an electronic device such as robot. The platform may receive a data stream from an interface of a data input source. Data in the data stream may include original point cloud data of each frame collected by a laser sensor in real time, and scan data can be obtained by processing these original point cloud data. Processing of the original point cloud data will be introduced below.

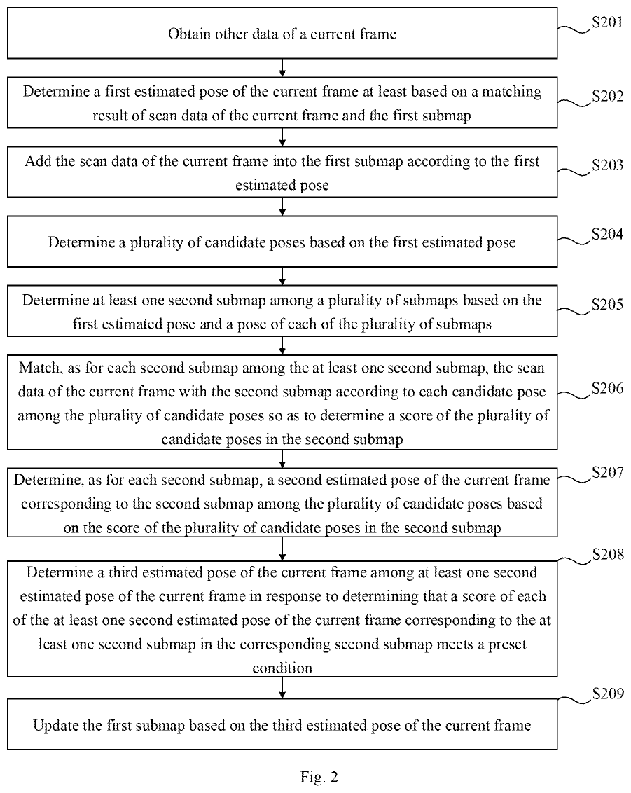

According to some embodiments, the data in the data stream may further include data collected by other sensors, for example, may include wheel odometry data collected by a wheel odometry and IMU data collected by an inertial measurement unit (IMU). As shown in FIG. 2, the method for localization and mapping may further include step S201, other data of the current frame are obtained. It can be understood that operations of steps S202-S204 and S206-S209 in FIG. 2 are similar to operations of steps S101-S107 in FIG. 1 and will not be repeated here.

The wheel odometry data, inertial measurement unit data and the like may be used for performing preliminary estimation on a pose of the current frame. A pose estimated by using these data has a relatively high confidence coefficient within a short time, a large error accumulation may be caused after use for a long time, so the scan data of the current frame may be matched with the scan data of the preceding frame, a roughly estimated pose is corrected according to the matching result, and thus accurate pose estimation is obtained. It can be understood that the preceding frame may be a frame collected before the current frame in terms of time. The preceding frame may be one or more frames preceding the current frame and adjacent to the current frame, or may be one or more frames preceding the current frame and not adjacent to the current frame (that is, spaced from the current frame at intervals of at least one frame), which is not limited herein.

According to some embodiments, an input data stream may be processed by using an SLAM front end. In some embodiments, voxel filtering may be performed on the original point cloud data so as to obtain the scan data. The quantity of point clouds can be reduced by using a voxel filtering mode, and hashrate and time consumed during subsequent matching of the scan data and the submap is reduced. As for other data such as the wheel odometry data, the IMU data, pose incremental updating may be performed according to these data so as to obtain an original to-be-matched pose.

According to some embodiments, the pose may include a plurality of pose components, for example, may include at least one of a position component in a first direction (x direction), a position component in a second direction (y direction), or a yaw angle component. A pose of a frame can indicate information such as a position and an orientation of an electronic device when it obtains the frame. In other words, the pose of the frame can indicate a mapping relation between a coordinate system of scan data of the frame and an absolute coordinate system.

According to some embodiments, the first submap may be a submap under construction at present. The at least one preceding frame included by the first submap may be a frame, namely, a common-viewing-angle frame with the same viewing angle as the current frame, so as to enable viewing angles of all frames in the first submap to be basically the same. The submap is constructed by using the common-viewing-angle frame, so that it can be guaranteed that a difference between scenarios of all frames in the submap is small, and thus an error is reduced. In some embodiments, the submaps (including the first submap, the second submap and other submaps) in the solution may be a raster map for convenient matching.

The pose of the first submap may be determined according to poses of these preceding frames, so that the pose of the first submap can indicate a mapping relation between a coordinate system of scan data of the at least one preceding frame included in the first submap (the scan data of these preceding frame may be converted into a coordinate system of the first submap when being added into the first submap, and the coordinate system of the first submap may also be adjusted due to adding of the scan data) and the absolute coordinate system.

Step S202, the scan data of the current frame may be matched with the first submap based on the original to-be-matched pose of the current frame and the pose of the first submap so as to determine the first estimated pose of the current frame. Similarly, the first estimated pose can indicate the mapping relation between the coordinate system of the scan data of the frame and the absolute coordinate system, so the first estimated pose and pose of the first submap can jointly indicate the mapping relation between the coordinate system of the scan data of the current frame and the coordinate system of the first submap. In some embodiments, the original to-be-matched pose may be directly used as the first estimated pose, or the original to-be-matched pose may be used as a center, and searching is performed within a range so as to determine the first estimated pose, which is not limited herein.

In step S203, adding the scan data of the current frame into the first submap based on the first estimated pose and the pose of the first submap may be, for example, adding the scan data of the current frame into the first submap by using an x coordinate, a y coordinate and a yaw angle indicated by the first estimated pose. Accordingly, the first submap may be updated based on the scan data of the current frame, and the updated first submap may be further processed by using an SLAM back end.

In step S204, during processing by the SLAM back end, the plurality of candidate poses may be determined within a range around the first estimated pose. It can be understood that those skilled in the art can determine a size of the range by himself according to demands for a hashrate and accuracy, which is not limited herein.

According to some embodiments, in step S204, determining the plurality of candidate poses within the range around the first estimated pose may include: as for each pose component among the plurality of pose components, a plurality of candidate values are determined within the range; and the plurality of candidate values of each of the plurality of pose components are combined so as to obtain the plurality of candidate poses. Furthermore, determining the plurality of candidate values within the range may include a float offset and a float step length of the component are determined, and then the plurality of candidate values are determined according to these two parameters. Accordingly, the plurality of candidate poses may be selected within a certain range under the condition of consuming smaller hashrate for matching, and the accuracy is guaranteed.

According to some embodiments, as shown in FIG. 2, the method may further include: step S205, at least one second submap is determined among a plurality of submaps based on the first estimated pose and a pose of each of the plurality of submaps. Accordingly, the at least one second submap is determined among all the submaps based on the first estimated pose of the current frame and the poses of the plurality of submaps, the quantity of second submaps needing to be matched can be reduced, and thus demand and consumption for the hashrate are reduced.

The plurality of submaps may include all submaps generated by the electronic device before, or may include a submap under generation at present (namely, the first submap), or may also include a submap guided into the electronic device in advance, which is not limited herein.

According to some embodiments, a difference between the first estimated pose and the pose of each second submap among the at least one second submap is smaller than a first threshold. Accordingly, a submap with a difference from the pose of the current frame being smaller than the first threshold is used as the second submap, submaps highly different from the first estimated pose are filtered out, a constraint which these submaps can provide is quite limited, so this type of filtering has a quite low influence on the accuracy of a finally obtained estimated pose, a calculating amount can be remarkably reduced, and it can be guaranteed that the method for localization and mapping can run in real time. It can be understood that those skilled in the art can set a corresponding first threshold according to the demands for the hashrate and the accuracy, which is not limited herein.

Those skilled in the art may also determine the second submap based on the first estimated pose of the current frame and the poses of the plurality of submaps by using the other modes. In an example, an accumulated error is caused by an error generated by the wheel odometry due to slipping of a wheel of the electronic device, so a plurality of submaps in front or in rear of the current frame in the direction of the yaw angle may also be used as the second submaps.

According to some embodiments, after the plurality of candidate poses and the plurality of submaps for matching are determined, the scan data of the current frame may be matched with the second submap based on each of the candidate poses. In some embodiments, the matching process uses high-accuracy data with a resolution being greater than a second threshold. In an example embodiment, the second threshold is 0.01 cm.

In some situations, in order to solve a problem of inaccurate input data and few input source, a mode of a low resolution and a large searching range is adopted, moreover, the first submap under generation at present is matched with a second submap historically generated, and thus pose estimation is performed based on richer constrain conditions. In some embodiments, the present disclosure can obtain an accurate result under the condition of consuming less hashrate by using the high-accuracy scan data and submap data and performing searching on the scan data and the submaps within a small range.

In step S206, as for each second submap, the scan data of the current frame may be matched with the second submap based on each of the candidate poses so as to obtain a score as for each of the candidate poses.

According to some embodiments, step S207, as for each second submap, determining the second estimated pose of the current frame corresponding to the second submap among the plurality of candidate poses based on the score of the plurality of candidate poses in the second submap may include: a candidate pose with the highest score in the second submap among the plurality of candidate poses is determined to be the second estimated pose of the second submap.

Accordingly, through step S206 and step S207, a best second estimated pose as for each of the second submap can be obtained, and then whether the first submap needs to be updated may be judged according to scores of these second estimated poses.

According to some embodiments, determining the scores of the plurality of candidate poses as for each second submap is executed in series. In some situations, searching needs to be performed in a large range, so matching of the second submap by the first submap is processed by using a thread pool mode. A thread pool per se greatly consumes hashrate, and a problem of task stacking will be caused. Besides, when the thread pool is used under lower hashrate, not timely processing of the data stream may cause its deformation in whole and an error of a mapping scale, and even a local mapping effect has a serious ghosting. In some embodiments, the present disclosure determines the score of each candidate pose in each second submap by using a series mode, a next frame is processed after processing of a whole flow is finished, not only can a calculating real-time property be guaranteed, but also consumption of the hashrate caused by the thread pool per se can be removed.

According to some embodiments, the predetermined condition indicates that a score of at least one of the at least one second estimated pose in the corresponding second submap is greater than a third threshold. In other words, the score of at least one second estimated pose of the at least one second estimated pose in the corresponding second submap is greater than the third threshold. Step S208, determining the third estimated pose of the current frame among the at least one second estimated pose of the current frame may include: a second estimated pose with the highest score in the corresponding second submap among the at least one second estimated pose is determined to be a third estimated pose. Accordingly, when it is determined that the accuracy of the these second estimated poses may be better than the first estimated pose, the best third estimated pose is determined among these second estimated poses, so as to realize accurate estimation of the pose of the current frame and correct the first submap.

According to some embodiment, in response to detecting that the above predetermined condition is not met, the first estimated pose may be used as a final pose estimation result of the current frame.

In step S209, updating the scan data of the current frame in the first submap based on the third estimated pose may include: loopback optimization is performed on the scan data of the current frame in the first submap based on the third estimated pose. In some embodiments, loopback optimization may be performed on the scan data of the current frame in the first submap by using any loopback optimization algorithm so as to obtain a more accurate first submap.

After step S209 is executed, links such as next round of data collection, localization and mapping may be performed. When it is detected that a viewing angle of a next frame is different from the viewing angle of the first submap, the first submap may be completed and determined to be the second submap, and then a new first submap may be created starting from the next frame.

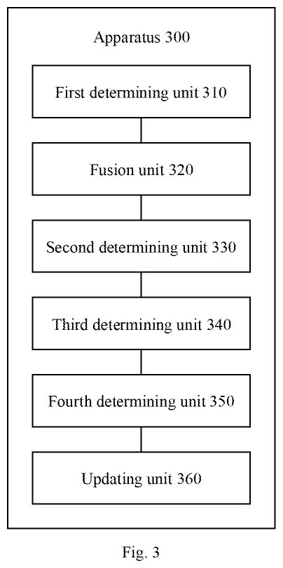

According to an aspect of the present disclosure, an apparatus for localization and mapping is disclosed. As shown in FIG. 3, the apparatus 300 includes: a first determining unit 310, configured to determine a first estimated pose of a current frame at least based on a matching result of scan data of the current frame and a first submap and a pose of the first submap, wherein the first submap include scan data of at least one preceding frame with the same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame; a fusion unit 320, configured to add the scan data of the current frame into the first submap based on the first estimated pose and the pose of the first submap; a second determining unit 330, configured to determine a plurality of candidate poses within a range around the first estimated pose; a third determining unit 340, configured to as for each second submap among at least one second submap: match the scan data of the current frame with the second submap based on each candidate pose among the plurality of candidate poses and a pose of the second submap so as to determine a score of the plurality of candidate poses in the second submap; and determine a second estimated pose of the second submap among the plurality of candidate poses based on the score of the plurality of candidate poses in the second submap; a fourth determining unit 350, configured to determine a third estimated pose among at least one second estimated pose in response to determining that a score of the at least one second estimated pose of each of the at least one second submap in the corresponding second submap meets a predetermined condition; and an updating unit 360, configured to update the scan data of the current frame in the first submap based on the third estimated pose.

It can be understood that operations and effects of the units 310-330 and 350-360 in the apparatus 300 are respectively similar to operations and effects of steps S101-S103 and S106-S107 in FIG. 1, and an operation of the unit 340 is similar to operations of steps S104-S105, which is not repeated here.

In the technical solution of the present disclosure, involved collection, saving, use, processing, transport, providing and disclosure and other processing of user personal information conform to related laws and regulations without violating public order and good custom.

According to embodiments of the present disclosure, an electronic device, a readable storage medium and a computer program product are further provided.

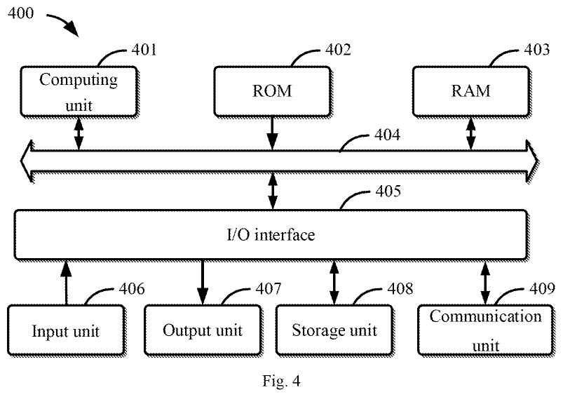

Referring to FIG. 4, a structural block diagram of an electronic device 400 which can be used as a server or a client of the present disclosure is described now, which is an example of a hardware device applicable to various aspects of the present disclosure. The electronic device intends to represent digital-electronic computer devices in various forms, such as a laptop computer, a desktop computer, a workbench, a personal digital assistant, a server, a blade server, a mainframe computer and other suitable computers. The electronic device may further represent mobile apparatuses in various forms, such as the personal digital assistant, a cell phone, a smartphone, a wearable device and other similar computing apparatuses. Components and their connections, relations and functions shown herein are only used as examples rather than intending to limit implementation of the present disclosure described and/or claimed herein.

As shown in FIG. 4, the device 400 includes a computing unit 401, which can execute various appropriate actions and processing according to a computer program stored in a read-only memory (ROM) 402 or a computer program loaded to a random access memory (RAM) 403 from a storage unit 408. In the RAM 403, various programs and data required for operation of the device 400 may be further stored. The computing unit 401, the ROM 402 and the RAM 403 are mutually connected through a bus 404. An input/output (I/O) interface 405 is also connected to the bus 404.

A plurality of components in the device 400 are connected to the I/O interface 405, including: an input unit 406, an output unit 407, the storage unit 408 and a communication unit 409. The input unit 406 may be any type of devices capable of inputting information into the device 400, and the input unit 406 can receive input numbers or character information and generate a key signal input related to user setting and/or function control of the electronic device and may include but not limited to a mouse, a keyboard, a touch screen, a trackpad, a trackball, a joystick, a microphone and/or a remote control unit. The output unit 407 may be any type of devices capable of displaying information and may include but not limited to a display, a speaker, a video/audio output terminal, a vibrator and/or a printer.

The storage unit 408 may include but not limited to a magnetic disk and an optical disc. The communication unit 409 allows the device 400 to exchange information/data with other devices through a computer network, such as Internet, and/or various telecommunication networks and may include but not limited to a modem, a network card, an infrared communication device, a wireless communication transceiver and/or chip set, for example, a Bluetooth™ device, a 802.11 device, a WiFi device, a WiMax device, a cellular communication device and/or similar items.

The computing unit 401 may be various general-purpose and/or special-purpose processing components with processing and computing capacity. Some examples of the computing unit 401 include but not limited to a central processing unit (CPU), a graphics processing unit (GPU), various special-purpose artificial intelligence (AI) computing chips, various computing units for running a machine learning network algorithm, a digital signal processor (DSP), and any appropriate processor, controller, microcontroller and the like. The computing unit 401 executes each method and processing described above, for example, the method for localization and mapping. For example, in some embodiments, the method for localization and mapping may be realized as a computer software program, which is tangibly contained in a machine readable medium, for example, the storage unit 408. In some embodiments, a part of or all of computer programs may be loaded and/or installed onto the device 400 via the ROM 402 and/or the communication unit 409. When the computer programs are loaded to the RAM 403 and executed by the computing unit 401, one or more steps of the method for localization and mapping described above can be executed. Alternatively or additionally, in other embodiments, the computing unit 401 may be configured to execute the method for localization and mapping in any other appropriate mode (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and interact usually through a communication network. A relation between the client and the server is generated by running the computer program with a mutual client-server relation on a corresponding computer. The server may be a cloud server, also called a cloud computing server or a cloud host, and is a host product in a cloud computing service system so as to overcome defects of high management difficulty and weak service expansibility in a traditional physical host and a virtual private server (VPS) service. The server may also be a server of a distributed system, or a server combined with a block chain.

It should be understood that steps can be reranked, added or deleted by using various forms of flows shown above. For example, all the steps recorded in the present disclosure can be executed in parallel, or in sequence or in different orders, which is not limited herein as long as a desired result of the technical solutions disclosed by the present disclosure can be realized.

Though the embodiments or examples of the present disclosure are already described with reference to the accompanying drawings, it should be understood that the above method, system and device are only embodiments or examples, the scope of the present disclosure is not limited by these embodiments or examples but limited by only the scope of authorized claims and their equivalents. Various elements in the embodiments or examples may be omitted or replaced by their equivalent elements. Besides, all the steps can be executed in a sequence different from the sequence described in the present disclosure. Furthermore, various elements in the embodiments or examples can be combined in various modes. What counts is that with evolution of technologies, many elements described herein may be replaced by equivalent elements appearing after the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for localization and mapping, comprising:
determining a first estimated pose of a current frame at least based on a pose of a first submap and a matching result of scan data of the current frame and the first submap, wherein the first submap comprises scan data of at least one preceding frame with a same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame;
adding the scan data of the current frame into the first submap based on the first estimated pose and the pose of the first submap;
determining a plurality of candidate poses within a range around the first estimated pose;
for each second submap of at least one second submap:
matching the scan data of the current frame with the second submap based on each candidate pose of the plurality of candidate poses and a pose of the second submap to determine a score of each of the plurality of candidate poses in the second submap; and
determining a second estimated pose of the current frame corresponding to the second submap from the plurality of candidate poses based on the score of each of the plurality of candidate poses in the second submap;
in response to determining that a score of each second estimated pose of at least one second estimated pose of the current frame corresponding to the at least one second submap in the corresponding second submap meets a criterion, determining a third estimated pose of the current frame from the at least one second estimated pose of the current frame; and
updating the scan data of the current frame in the first submap based on the third estimated pose of the current frame.

2. The method according to claim 1, further comprising:
determining the at least one second submap from a plurality of submaps based on the first estimated pose and a pose of each submap of the plurality of submaps.

3. The method according to claim 2, wherein a difference between the first estimated pose and the pose of each second submap of the at least one second submap is less than a first threshold.

4. The method according to claim 1, wherein a resolution of the scan data of the current frame and a resolution of the second submap are both greater than a second threshold.

5. The method according to claim 1, wherein the first estimated pose comprises a plurality of pose components, and
wherein determining the plurality of candidate poses within the range around the first estimated pose comprises:
determining, for each pose component of the plurality of pose components, a plurality of candidate values within the range; and
combining the plurality of candidate values for each pose component of the plurality of pose components to obtain the plurality of candidate poses.

6. The method according to claim 5, wherein the plurality of pose components comprise at least one of a first direction position component, a second direction position component or a yaw angle component.

7. The method according to claim 1, further comprising:
obtaining other data of the current frame, wherein the other data comprise at least one of odometry data or inertial measurement unit data, and
wherein determining the first estimated pose of the current frame at least based on the pose of the first submap and the matching result of the scan data of the current frame and the first submap comprises:
determining the first estimated pose of the current frame based on the pose of the first submap, the other data of the current frame, and the matching result of the scan data of the current frame and the first submap.

8. The method according to claim 1, wherein the criterion indicates that a score of at least one second estimated pose of the at least one second estimated pose in the corresponding second submap is greater than a third threshold, and
wherein determining the third estimated pose from the at least one second estimated pose comprises:
determining a second estimated pose with a highest score in the corresponding second submap from the at least one second estimated pose to be the third estimated pose.

9. The method according to claim 1, wherein determining the second estimated pose of the second submap from the plurality of candidate poses based on the score of the plurality of candidate poses in the second submap comprises:
determining a candidate pose with a highest score in the second submap from the plurality of candidate poses to be the second estimated pose of the second submap.

10. The method according to claim 1, wherein updating the scan data of the current frame in the first submap based on the third estimated pose comprises:
performing loopback optimization on the scan data of the current frame in the first submap based on the third estimated pose.

11. The method according to claim 1, wherein determining the score of the plurality of candidate poses in the second submap is executed in series.

12. The method according to claim 1, wherein the scan data are obtained by performing voxel filtering on original point cloud data obtained using a laser sensor.

13. The method according to claim 1, wherein both the first submap and the second submap are raster maps.

14. An electronic device, comprising:
one or more processors;
a memory storing one or more programs configured to be executed by the one or more processors, the one or more programs including instructions for the processors to perform acts including:
determining a first estimated pose of a current frame at least based on a pose of a first submap and a matching result of scan data of the current frame and the first submap, wherein the first submap comprises scan data of at least one preceding frame with a same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame;
adding the scan data of the current frame into the first submap based on the first estimated pose and the pose of the first submap;
determining a plurality of candidate poses within a range around the first estimated pose;
for each second submap of at least one second submap:
matching the scan data of the current frame with the second submap based on each candidate pose of the plurality of candidate poses and a pose of the second submap to determine a score of each of the plurality of candidate poses in the second submap; and
determining a second estimated pose of the current frame corresponding to the second submap from the plurality of candidate poses based on the score of each of the plurality of candidate poses in the second submap;
in response to determining that a score of each second estimated pose of at least one second estimated pose of the current frame corresponding to the at least one second submap in the corresponding second submap meets a criterion, determining a third estimated pose of the current frame from the at least one second estimated pose of the current frame; and
updating the scan data of the current frame in the first submap based on the third estimated pose.

15. The electronic device according to claim 14, wherein the acts further include:
determining the at least one second submap from a plurality of submaps based on the first estimated pose and a pose of each submap of the plurality of submaps.

16. The electronic device according to claim 15, wherein a difference between the first estimated pose and the pose of each second submap of the at least one second submap is less than a first threshold.

17. The electronic device according to claim 14, wherein a resolution of the scan data of the current frame and a resolution of the second submap are both greater than a second threshold.

18. A non-transient computer-readable storage medium storing one or more programs, the one or more programs comprising instructions, which when executed by one or more processors of an electronic device, cause the electronic device to:
determine a first estimated pose of a current frame at least based on a pose of a first submap and a matching result of scan data of the current frame and the first submap, wherein the first submap comprises scan data of at least one preceding frame with a same viewing angle as the current frame, the first estimated pose and the pose of the first submap jointly indicate a mapping relation between a coordinate system of the scan data of the current frame and a coordinate system of the first submap, and the pose of the first submap is determined based on a pose of the at least one preceding frame;
add the scan data of the current frame into the first submap based on the first estimated pose and the pose of the first submap;
determine a plurality of candidate poses within a range around the first estimated pose;
for each second submap of at least one second submap:
match the scan data of the current frame with the second submap based on each candidate pose of the plurality of candidate poses and a pose of the second submap to determine a score of each of the plurality of candidate poses in the second submap; and
determine a second estimated pose of the current frame corresponding to the second submap from the plurality of candidate poses based on the score of each of the plurality of candidate poses in the second submap;
in response to determining that a score of each second estimated pose of at least one second estimated pose of the current frame corresponding to the at least one second submap in the corresponding second submap meets a criterion, determine a third estimated pose of the current frame from the at least one second estimated pose of the current frame; and
update the scan data of the current frame in the first submap based on the third estimated pose of the current frame.

19. The non-transient computer-readable storage medium according to claim 18, wherein the first estimated pose comprises a plurality of pose components, and
wherein determining the plurality of candidate poses within the range around the first estimated pose comprises:
determining, for each pose component of the plurality of pose components, a plurality of candidate values within the range; and
combining the plurality of candidate values for each pose component of the plurality of pose components to obtain the plurality of candidate poses.

20. The non-transient computer-readable storage medium according to claim 19, wherein the plurality of pose components comprise at least one of a first direction position component, a second direction position component or a yaw angle component.
